(19) United States
(12) Patent Application Publication
(10) Pub. No.: US 2018/0341924 A1
(43) Pub. Date: Nov. 29, 2018

(54) CALENDAR APPLICATION, SYSTEM AND METHOD FOR PROVIDING MULTIPLE TIME ZONE CALENDAR VIEWS DURING TRAVEL BETWEEN TIME ZONES

(71) Applicant: salesforce.com, inc., San Francisco, CA (US)

(72) Inventors: Anthony Desportes, San Francisco, CA (US); Eric Alexander Hurlima Perret, San Francisco, CA (US); Kapildev Reddy Gowru, San Francisco, CA (US); Tigran Abovyan, North Bergen, NJ (US); Ravi L. Honakere, San Ramon, CA (US); Kayvaan Ghassemieh, San Francisco, CA (US); Vatsal Shah, Hayward, CA (US)

(73) Assignee: salesforce.com, inc., San Francisco, CA (US)

(21) Appl. No.: 15/606,998

(22) Filed: May 26, 2017

(51) Int. Cl. G06Q 10/10; G06Q 10/06; G06F 17/30

(52) U.S. Cl. CPC G06Q 10/1093; G06F 17/30017; G06Q 10/063116

(57) ABSTRACT

Methods and systems are provided for generating a calendar view of a schedule that includes a time zone adjusted travel event and calendar items. When a user creates a travel event on a calendar, an adjusted duration for the travel event is computed, and the travel event is then scheduled according to the adjusted duration. The travel event takes place over a first time zone of a starting location that a user departs from at a departure time, and a second (different) time zone of an ending location that the user arrives at an arrival time. The adjusted duration for the travel event that is time-adjusted, based on time zones that the travel event takes place over, to account for any transitions between the time zones that occur during the travel event. Other calendar items that occur on the travel date and are to be displayed in a main user interface of a calendar application can also be detected. A single schedule is then displayed in the main user interface of the calendar application that includes the travel event and each of the other calendar items. The travel event is displayed within the single schedule such that the travel event is rendered to have the adjusted duration that is time-adjusted to account for any transitions between the time zones that occur during the travel event.

### TECHNICAL FIELD

Embodiments of the subject matter described herein relate generally to cloud-based computing. More particularly, embodiments of the subject matter relate to a calendar application, system and method for providing multiple time zone calendar views when a user travels between time zones.

### BACKGROUND

Many professionals (e.g., sales and marketing professionals, engineers, attorneys, etc.) typically manage their day using an electronic calendar. Various calendar applications are in use today, including iCal™, Google™ Calendar, Microsoft™ Office 365, Microsoft™ Outlook with Exchange Server, Yahoo™ Calendar, and iCloud™ mail to name a few. These applications present an interface that allows a user to create an event at a specified time, such as a meeting, task or appointment. Most calendar applications also allow a user to send invite requests for events to other users. When an invitee receives the request, the invitee can choose to accept or decline the request. If the invitee accepts, a corresponding event is typically created in the invitee's calendar. Typical calendar applications provide basic views such as a day view, a week view, and a month view. This allows the user to track various events that are scheduled throughout their day, week or month depending on the view they have selected.

Events displayed in a calendar are typically displayed relative to the user's primary time zone where the user is normally located. Most existing calendar systems and applications are stuck in a 24 hour per day view that is set to a specific time zone, and do not differentiate between a regular calendar event (e.g., a meeting or a task) and a trip that involves crossing different time zones. In other words, presently known calendaring applications do not take into account the effect that travel between different time zones can have on the calendar events that are displayed on the calendar.

This can make it difficult for a user who is travelling between time zones to easily understand the actual schedule of when certain events are occurring. As such, existing calendar applications can be difficult for a user to understand when a user is traveling between time zones (e.g., can make it difficult to schedule meetings and manage the user's time).

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram of an example of a multi-tenant computing environment in which features of the disclosed embodiments can be implemented in accordance with some of the disclosed embodiments.

FIG. 2 is a block diagram of a system in which features of the disclosed embodiments can be implemented in accordance with some of the disclosed embodiments.

FIG. 3 is a screenshot that shows a calendar day view of the main UI of a calendar application including a ruler that shows a schedule timeline and three calendar items scheduled during that day.

FIG. 4 is a flow chart that illustrates an exemplary method for generating a calendar view of a schedule that includes time zone adjusted calendar items in accordance with the disclosed embodiments.

FIG. 5 is a screenshot that shows a travel event creation element provided by a calendar application in accordance with the disclosed embodiments.

FIG. 6 is a screenshot that shows an adjusted calendar day view of the main UI of a calendar application including a ruler that shows an adjusted schedule timeline in accordance with the disclosed embodiments.

FIG. 7 is a flow chart that illustrates an exemplary method for computing an adjusted duration for a travel event or other calendar item in accordance with the disclosed embodiments.

FIG. 8 shows a block diagram of an example of an environment in which an on-demand database service can be used in accordance with some implementations.

FIG. 9 shows a block diagram of example implementations of elements of FIG. 8 and example interconnections between these elements according to some implementations.

FIG. 10A shows a system diagram illustrating example architectural components of an on-demand database service environment according to some implementations.

FIG. 10B shows a system diagram further illustrating example architectural components of an on-demand database service environment according to some implementations.

FIG. 11 illustrates a diagrammatic representation of a machine in the exemplary form of a computer system within which a set of instructions, for causing the machine to perform any one or more of the methodologies discussed herein, may be executed.

### DETAILED DESCRIPTION

It would be desirable to provide calendaring systems and applications that can account for a user's travel between different time zones and provide the user with a more accurate view of their schedule when the user is traveling between different time zones. It would be desirable if this new view can reflect various calendar items including a travel event as the user experiences them throughout the day, as opposed to a view that is tied to a specific time zone, such as the time zone the user departed from (or time zone of origin), but is no longer located in.

To address the issues discussed above, systems, methods, procedures, and technology are provided for generating a calendar view of a schedule that includes a time zone adjusted travel event and calendar items. When a user creates a travel event on a calendar, an adjusted duration for the travel event is computed, and the travel event is then scheduled according to the adjusted duration. To explain further, the travel event takes place over a first time zone of a starting location that a user departs from at a departure time, and a second (different) time zone of an ending location that the user arrives at an arrival time. The adjusted duration for the travel event that is time-adjusted, based on time zones that the travel event takes place over, to account for any transitions between the time zones that occur during the travel event. Other calendar items that occur on the travel date and are to be displayed in a main user interface of a calendar application can also be detected. A single schedule is then displayed in the main user interface of the calendar application that includes the travel event and each of the other calendar items. The travel event is displayed within the single schedule such that the travel event is rendered to have the adjusted duration that is time-adjusted to account for any transitions between the time zones that occur during the travel event. Stated another way, the adjusted duration for the travel event is time-adjusted to start at the departure time in the first time zone and end at the arrival time in the second time zone such that the travel event is scheduled over a time range that reflects the departure time in the first time zone and the arrival time in the second time zone to provide an adjusted view of the calendar that takes into account travel between time zones during travel event including either time lost when the time zone of the ending location lags the time zone of the starting location, or time gained when the time zone of the ending location leads the time zone of the starting location. This way, the user is provided with an adjusted view of the calendar that takes into account travel between time zones during travel event (e.g., as the user travels between the time zones).

In one embodiment, the calendar application can determine a relative time zone differential between the first time zone of the starting location and the second time zone of the ending location, and then, determine whether the second time zone of the ending location lags or leads the first time zone of the starting location. When the second time zone of the ending location lags the first time zone of the starting location, the calendar application can compute the adjusted duration of the travel event based on the difference between an actual total travel time between the ending location and the starting location, and the relative time zone differential. By contrast, when the second time zone of the ending location leads the second time zone of the starting location, the calendar application can compute the adjusted duration for the travel event based on the sum of the actual total travel time between the ending location and the starting location, and the relative time zone differential. The actual total travel time can be determined in different ways depending on the implementation. For instance, in one implementation, the actual total travel time is the total travel time between an anticipated arrival of the user at the ending location and an anticipated departure of the user from the starting location. However, in other implementations, the actual total travel time can be estimated based on real-time information provided from other sources such as a navigation system of the transport vehicle, or from a computing device carried by the user that has capability of determining the actual total travel time.

Thus, in contrast to other calendar systems and applications, the disclosed embodiments can schedule and display a travel event and other calendar items in a single schedule presented on the main calendar UI according to the time zones where they are scheduled to take place. The starting and ending times of the travel event can be adjusted to provide an adjusted calendar view where the duration of the travel event is adjusted (e.g., the travel event can be scheduled according to an adjusted duration that is time adjusted based on time zones where the travel event is scheduled to take place). This way when the travel event is presented on the main UI of the calendar application it can start at a scheduled departure time in the first time zone and end at a scheduled arrival time in the second (or destination) time zone. As such, in the adjusted calendar view, the travel event can be scheduled over a time range that reflects the departure time in one time zone and the arrival time in another time zone, but can still be shown as covering a time block having a duration that reflects the actual time spent traveling though time zones.

For other calendar items that are displayed on the day of the travel event, the calendar application can determine, based on the travel information, whether each calendar item is scheduled to take place before the departure time of the travel event, during the travel event, or after the arrival time of the travel event.

For each calendar item that is scheduled to take place before the departure time of the travel event, the calendar application can schedule those calendar items according to a scheduled time in the first time zone where each calendar item is scheduled to take place, and then display each of those calendar items (within the single schedule in the main user interface of the calendar application) so that each is scheduled according to a scheduled time in the first time zone where that calendar item is scheduled to take place.

For each calendar item that is scheduled to take place during the travel event, the calendar application can compute an adjusted duration that is time-adjusted based on the time zones where that calendar item is scheduled to take place during the travel event. The calendar application can schedule each of those calendar items according to the adjusted duration of that calendar item, and then display those calendar items (within the single schedule in the main user interface of the calendar application) so that each is time-adjusted based on one or more time zones where that calendar item is scheduled to take place (e.g., any calendar items that take place over two or more time zones are displayed within the single schedule using the adjusted duration for that calendar item). The adjusted durations can be computed in a manner similar to that described above with reference to the travel event.

For each calendar item that is scheduled to take place after the arrival time of the travel event, the calendar application can schedule each calendar item so that each calendar item is time-adjusted to an equivalent scheduled time in the second time zone when that calendar item is scheduled to take place, and then display those calendar items (within the single schedule in the main user interface of the calendar application) so that each is time-adjusted according to the equivalent schedule time in the second time zone where that calendar item is scheduled to take place. Thus, in contrast to other calendar systems and applications, for each calendar item that is scheduled to take place after the arrival time on the day of the travel event, the disclosed embodiments can schedule and display those calendar items so that the starting and ending times for each of those calendar items are specified in terms of their respective times in the destination time zone to take into account that a time zone change has occurred. For instance, in one implementation, a vertical ruler that is used to demarcate the start and end time of each calendar item can be adjusted to reflect the time in the destination time zone (e.g., as opposed to the times in the time zone of origin) so that any calendar items that happen after the time zone transition (e.g., that are scheduled to take place after the arrival time of the travel event) correctly reflect the time in the new destination time zone. In other words, those calendar items will be scheduled according to an equivalent scheduled time in the destination time zone of the ending location (e.g., where the travel event ends) so that they have an adjusted duration or timing that is time adjusted based on time zone where they are scheduled to take place. This way the user has a clearer visual representation regarding when these calendar items actually take place in the context to the adjusted day view (e.g., in the time zone where it actually occurs).

In the examples that follow, the calendar application will be described in the context of a cloud-based calendar application and system. Although the embodiments described herein can be implemented in the context of any cloud-based computing environment including, for example, a multi-tenant database system, it should be appreciated that this environment is non-limiting and that the disclosed embodiments can also be applied in the context of other non-cloud-based calendar applications and systems. For example, the disclosed embodiments could also be applied in the context of networked calendar applications, mobile calendar applications, etc.

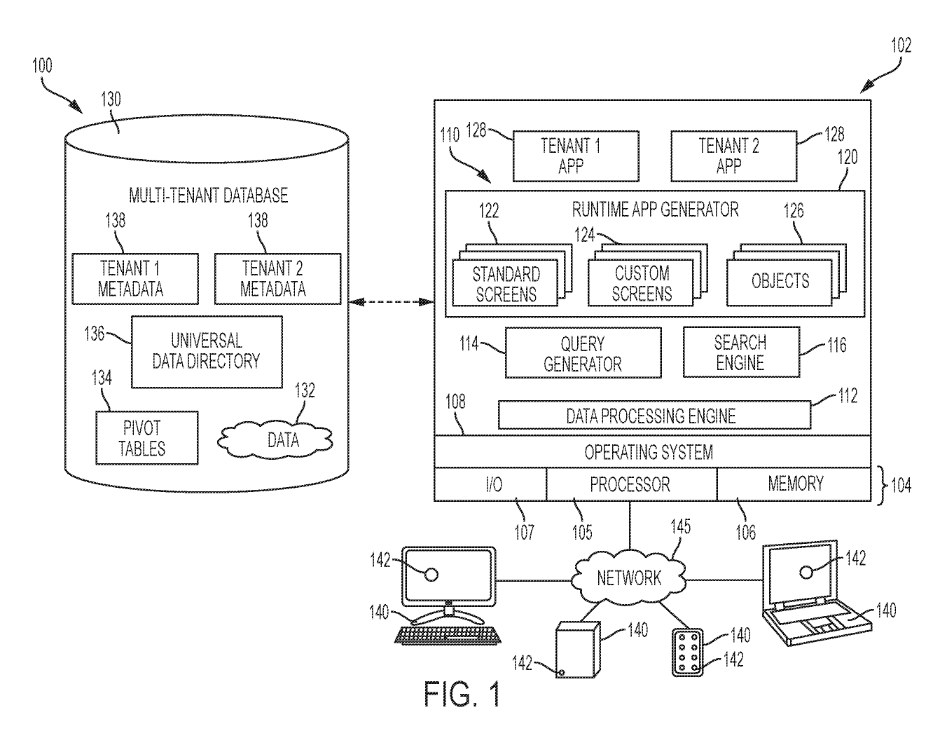

FIG. 1 is a schematic block diagram of an example of a multi-tenant computing environment in which features of the disclosed embodiments can be implemented in accordance with the disclosed embodiments. As shown in FIG. 1, an exemplary cloud based solution may be implemented in the context of a multi-tenant system 100 including a server 102 that supports applications 128 based upon data 132 from a database 130 that may be shared between multiple tenants, organizations, or enterprises, referred to herein as a multi-tenant database. Data and services generated by the various applications 128 are provided via a network 145 to any number of user systems 140, such as desktops, laptops, tablets, smartphones or other client devices, Google Glass™, and any other computing device implemented in an automobile, aircraft, television, or other business or consumer electronic device or system, including web clients.

Each application 128 is suitably generated at run-time (or on-demand) using a common application platform 110 that securely provides access to the data 132 in the database 130 for each of the various tenant organizations subscribing to the system 100. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the user systems 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the user systems 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user systems 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its user system 140, as appropriate.

The runtime application generator 120 suitably interacts with the query generator 114 to efficiently obtain multi-tenant data 132 from the database 130 as needed in response to input queries initiated or otherwise provided by users of the user systems 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled user system 140 on the network 145. In an exemplary embodiment, the user system 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the user system 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the user system 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128. In various embodiments, application 128 embodies the functionality of a collaboration solution such as the Chatter system, described below.

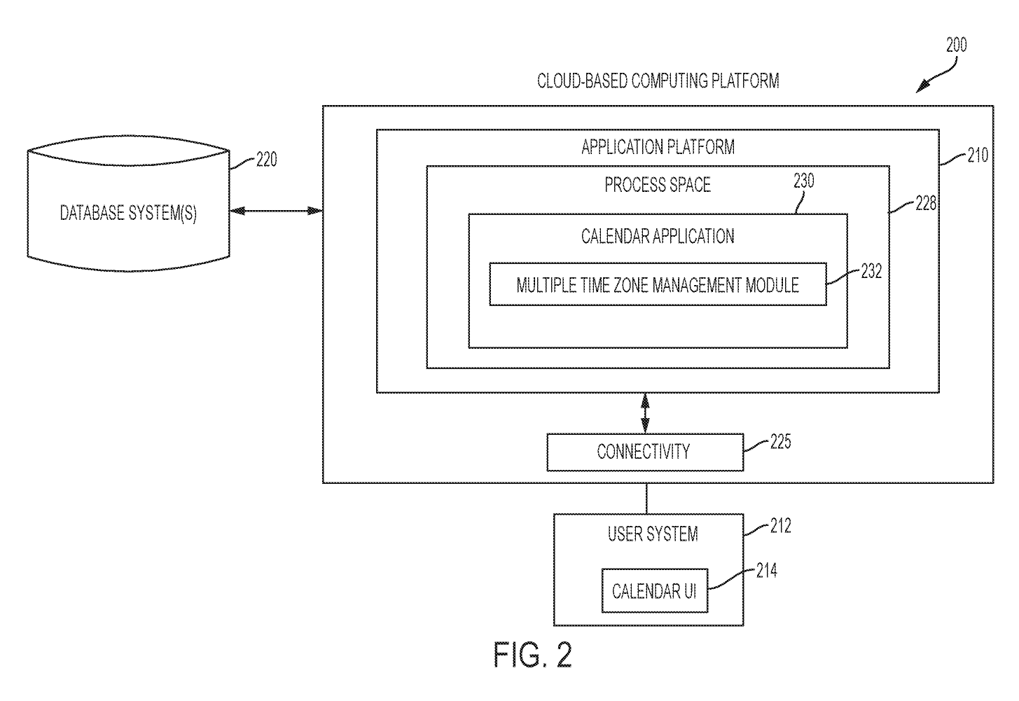

FIG. 2 is a block diagram of a cloud-based computing platform 200 in accordance with the disclosed embodiments. The cloud-based computing platform 200 is a system that can be shared by many different organizations, and handles the storage of, and access to, different metadata, objects, data and applications across disparate organizations. In one embodiment, the cloud-based computing platform 200 can be part of a database system, such as a multi-tenant database system. The cloud-based computing platform 200 is configured to handle requests for any user associated with any organization that is a tenant of the system. Although not illustrated, the cloud-based computing platform 200 can include other components such as one or more processing systems that execute applications, other process spaces where other applications run, and program code that will be described in greater detail below.

The cloud-based computing platform 200 includes a connectivity engine 225 serves as a network interface that allows a user of a user system 212 to establish a communicative connection to the cloud-based computing platform 200 over a network (not illustrated in FIG. 2) such as the Internet or any type of network described herein.

The cloud-based computing platform 200 includes an application platform 210 and one or more user systems 212 that can access various applications provided by the application platform 210. The application platform 210 is a cloud-based user interface.

The cloud computing platform 200 (including the application platform 210 and database systems 220) are part of one backend system. Although not illustrated, the could computing platform 200 can include other backend systems that can include one or more servers that work in conjunction with one or more databases and/or data processing components, and the application platform 210 can access the other backend systems.

The application platform 210 has access to one or more database systems 220 that store information (e.g., data and metadata) for a number of different organizations including user information, organization information, custom information, etc. The database systems 220 can include a multi-tenant database system 130 as described with reference to FIG. 1, as well as other databases or sources of information that are external to the multi-tenant database system 130 of FIG. 1. In one embodiment, the multi-tenant database system 130 can store data in the form of records and customizations.

As used herein, the term “record” can refer to a particular occurrence or instance of a data object that is created by a user or administrator of a database service and stored in a database system, for example, about a particular (actual or potential) business relationship or project. An object can refer to a structure used to store data and associated metadata along with a globally unique identifier (called an identity field) that allows for retrieval of the object. In one embodiment implementing a multi-tenant database, all of the records for the tenants have an identifier stored in a common table. Each object comprises a number of fields. A record has data fields that are defined by the structure of the object (e.g. fields of certain data types and purposes). An object is analogous to a database table, fields of an object are analogous to columns of the database table, and a record is analogous to a row in a database table. Data is stored as records of the object, which correspond to rows in a database. The terms “object” and “entity” are used interchangeably herein. Objects not only provide structure for storing data, but can also power the interface elements that allow users to interact with the data, such as tabs, the layout of fields on a page, and lists of related records. Objects can also have built-in support for features such as access management, validation, formulas, triggers, labels, notes and attachments, a track field history feature, security features, etc. Attributes of an object are described with metadata, making it easy to create and modify records either through a visual interface or programmatically.

A record can also have custom fields defined by a user. A field can be another record or include links thereto, thereby providing a parent-child relationship between the records. Customizations can include custom objects and fields, Apex Code, Visualforce, Workflow, etc.

Examples of objects include standard objects, custom objects, and external objects. A standard object can have a pre-defined data structure that is defined or specified by a database service or cloud computing platform. A standard object can be thought of as a default object. For example, in one embodiment, a standard object includes one or more pre-defined fields that are common for each organization that utilizes the cloud computing platform or database system or service.

A few non-limiting examples of standard objects can include sales objects (e.g., accounts, contacts, opportunities, leads, campaigns, and other related objects); task and event objects (e.g., tasks and events and their related objects); support objects (e.g., cases and solutions and their related objects); salesforce knowledge objects (e.g., view and vote statistics, article versions, and other related objects); document, note, attachment objects and their related objects; user, sharing, and permission objects (e.g., users, profiles, and roles); profile and permission objects (e.g., users, profiles, permission sets, and related permission objects); record type objects (e.g., record types and business processes and their related objects); product and schedule objects (e.g., opportunities, products, and schedules); sharing and team selling objects (e.g., account teams, opportunity teams, and sharing objects); customizable forecasting objects (e.g., includes forecasts and related objects); forecasts objects (e.g., includes objects for collaborative forecasts); territory management (e.g., territories and related objects associated with territory management); process objects (e.g., approval processes and related objects); content objects (e.g., content and libraries and their related objects); chatter feed objects (e.g., objects related to feeds); badge and reward objects; feedback and performance cycle objects, etc. For example, a record can be for a business partner or potential business partner (e.g. a client, vendor, distributor, etc.) of the user, and can include an entire company, subsidiaries, or contacts at the company. As another example, a record can be a project that the user is working on, such as an opportunity (e.g. a possible sale) with an existing partner, or a project that the user is trying working on.

By contrast, a custom object can have a data structure that is defined, at least in part, by an organization or by a user/subscriber/admin of an organization. For example, a custom object can be an object that is custom defined by a user/subscriber/administrator of an organization, and includes one or more custom fields defined by the user or the particular organization for that custom object. Custom objects are custom database tables that allow an organization to store information unique to their organization. Custom objects can extend the functionality that standard objects provide.

In one embodiment, an object can be a relationship management entity having a record type defined within platform that includes a customer relationship management (CRM) database system for managing a company's relationships and interactions with their customers and potential customers. Examples of CRM entities can include, but are not limited to, an account, a case, an opportunity, a lead, a project, a contact, an order, a pricebook, a product, a solution, a report, a forecast, a user, etc. For instance, an opportunity can correspond to a sales prospect, marketing project, or other business related activity with respect to which a user desires to collaborate with others.

External objects are objects that an organization creates that map to data stored outside the organization. External objects are like custom objects, but external object record data is stored outside the organization. For example, data that's stored on premises in an enterprise resource planning (ERP) system can be accessed as external objects in real time via web service callouts, instead of copying the data into the organization.

The computing platform 200 can provide applications and services and store data for any number of organizations. Each organization is a source of metadata and data associated with that metadata that collectively make up an application. In one implementation, the metadata can include customized content of the organization (e.g., customizations done to an instance that define business logic and processes for an organization). Some non-limiting examples of metadata can include, for example, customized content that describes a build and functionality of objects (or tables), tabs, fields (or columns), permissions, classes, pages (e.g., Apex pages), triggers, controllers, sites, communities, workflow rules, automation rules and processes, etc. Data is associated with metadata to create an application. Data can be stored as one or more objects, where each object holds particular records for an organization. As such, data can include records (or user content) that are held by one or more objects. For example, a “calendar” object can hold calendar records of an organization.

Based on a user's interaction with a user system 212, the application platform 210 accesses an organization's data (e.g., records held by an object) and metadata that is stored at one or more database systems 220, and provides the user system 212 with access to applications based on that data and metadata. These applications can include a calendar application 230 that is executed or run in a process space 228 of the application platform 210 will be described in greater detail below. The user system 212 and various other user systems (not illustrated) can interact with the calendar application 230 provided by the cloud-based computing platform 200.

The calendar application 230 is executable to maintain one or more calendars that can be presented via a graphical interface 214 to a user of one of the user systems 212. The calendar application 230 may allow the user to create and maintain multiple calendars. Each calendar can be defined, for example, as a chart or series of pages showing the days, weeks, and months of a particular year, or giving particular seasonal information. This is also sometimes referred to as the calendar definition. The calendar definition can also hold data which occurs at a point in time relative to the timeframe being included and/or data which occurs over a period of time with a start and an end, relative to the timeframe being included.

The calendar application 230 may allow the user to create calendar items on particular days at particular times. As used herein, a calendar item can refer to a calendar event, or an instance of an object that has a date and/or time field such that it is calendarable and capable of being displayed within the context of the calendar. Examples of calendar items can include calendar events, calendar entries, calendarable records (or instances of objects), records or entities that meet the minimum requirements to be defined on and/or displayed in the calendar, etc. The minimum requirements are at least one date/time datum in a format allowing the item to be positioned on the calendar relative to the time displayed on the calendar. The calendar item may contain more data not specifically required by the minimum requirements for being displayed on a calendar.

One example of a calendar item is a calendar event. For instance, the calendar application 230 can allow a user to invite others to created calendar events as well as receive invitations from others to calendar events. The calendar application 230 may send an invitation to the other user, which can be accepted or declined. The calendar application 230 may also allow a user to set reminders for calendar events that trigger notifications (e.g., a reminder for a notification a certain amount of time before an event is scheduled to begin). The calendar application 230 may maintain a calendar by storing various forms of event information in one or more database systems 220. Event information may include, without limitation, an event name, the start and end times for the event, the invitees of the event, etc. In various embodiments, event information may be accessible to other processes. In accordance with the disclosed embodiments, a calendar item or calendar event can be a travel event that specifies information about a user's travel from one location to another.

Some calendar applications are local and designed for individual use, whereas others are networked applications that allow for the sharing of information between users. In addition, some calendar applications, such as the calendar application 230 of FIG. 2, are cloud-based to further extend users ability to share calendar information with other users. In this embodiment, the calendar application 230 is hosted via the cloud-based computing platform 200 to allow users to access their calendars from any computer or mobile device, and to also share information with other users. However, in other embodiments, the calendar application 230 can be a networked calendar application, or hosted locally at the user system 212. The calendar application 230 can vary depending on the implementation, and may be implemented by an existing calendar application, such as iCal™, Mozilla™ Sunbird, Windows™ Live Calendar, Google™ Calendar, Microsoft™ Office 365, Microsoft™ Outlook with Exchange Server, Salesforce.com Calendar, or using various features thereof.

The calendar application 230 can be customized by the user or administrator. Users can use the calendar application 230 to create and maintain various electronic calendars for each user. For example, a given user might have a work calendar, different group calendars within their work calendar, a personal calendar, children's calendar, etc. For instance, a group calendar can be used to display calendar events for certain groups that a user is involved in at work. A user can combine and merge different calendars together to gain a better picture of all events on all calendars.

The calendar application 230 can display each calendar showing dates and days of the week with various time slots for each day. The user can view a particular calendar by hourly view, work day view, full day view, work week view, full week view, month view, etc. The calendar application 230 includes an address book or list of contacts with information to enable a user to communicate with the contacts. The calendar application 230 also includes appointment functionality such as an appointment or meeting calendar that includes a list of appointments and the attendees for the appointments. In some implementations, the calendar application 230 can detect scheduling conflicts, notifying the participants of the conflict, and suggesting alternate meeting times. The calendar application 230 can interface with an electronic mail communication system that interfaces with an appointment calendar to send reminders and notify the attendees of invitations to different calendar events (e.g., meetings), send reminders regarding a scheduled calendar event to attendees, or to notify attendees of any issues arising with scheduled calendar events. The calendar application 230 can automatically provide appointment reminders to remind participants of an upcoming meeting, and also includes an attachment feature that allows users to attach files to an appointment so that those files can be shared with other attendees who are participating in the meeting. To facilitate meeting scheduling among several individuals, the calendar application 230 includes features to that allow users to share their availability with other attendees (where users can select how much detail is shared). The calendar application 230 may include scheduling features that automatically check schedules of all attendees and propose a mutually convenient meeting time to all of the attendees. This allows the invitees to suggest times that will work best for them, allowing the event organizer to pick a meeting time that works best for all of the participants. In addition, the calendar application 230 can include scheduling features that allow users to schedule resources to help facilitate the meeting such as room reservation, on-line meeting scheduling that distributes dial in numbers and URLs for on-line meetings, etc. Depending on the implementation, the calendar application 230 can also include other optional features such as calendar publishing that allows a user to publish select calendar information on a public or private link, and calendar exporting that allows a user to export selected calendars into various file formats.

In accordance with the disclosed embodiments, the calendar application 230 includes a multiple time zone management (MTZM) module 232. When executed by a processor, the MTZM module 232 can process travel information associated with a travel event that takes place over multiple time zones to compute an adjusted duration for the travel event (and other calendar items that are to be displayed on the date of the travel event). The adjusted duration is time-adjusted, based on time zones that the travel event takes place over, to account for any transitions between the time zones that occur during the travel event. The adjusted duration can start at a departure time in a first time zone and end at an arrival time in another time zone such that the travel event is scheduled over a time range that reflects the departure time in the one time zone and the arrival time in the another destination time zone. The adjusted duration can be used to provide an adjusted view of the calendar that takes into account travel between time zones during travel event including either time lost when the time zone of the ending location lags the time zone of the starting location, or time gained when the time zone of the ending location leads the time zone of the starting location. The MTZM module 232 can schedule the travel event according to the adjusted duration. The MTZM module 232 can also detect other calendar items that are to be displayed within the calendar, and adjust those other calendar items (when applicable). The MTZM module 232 can then render the adjusted calendar view for display in the main user interface 214 of the calendar application. The adjusted calendar view provides a single schedule that includes the travel event and each of the other calendar items, where the travel event is displayed within the single schedule such that the travel event reflects the adjusted duration that is time-adjusted to account for any transitions between the time zones that occur during the travel event.

The MTZM module 232 can determine whether each of the other calendar items is scheduled to take place: before the departure time of the travel event, during the travel event, or after the arrival time of the travel event, and then manage how those other calendar items are rendered in the main UI 214. The MTZM module 232 can render each calendar item, that is scheduled to take place after the arrival time of the travel event, so that it is time-adjusted according to the equivalent schedule time in the destination time zone where that calendar item is scheduled to take place. The MTZM module 232 can render each calendar item, that is scheduled to take place during the travel event, such that each calendar item is time-adjusted based on one or more time zones where that calendar item is scheduled to take place. For instance, any calendar items that take place over two or more time zones are displayed within the single schedule using the adjusted duration for that calendar item. The MTZM module 232 can render each calendar item, that is scheduled to take place before the departure time of the travel event, according to a scheduled time in the time zone of origin where that calendar item is scheduled to take place

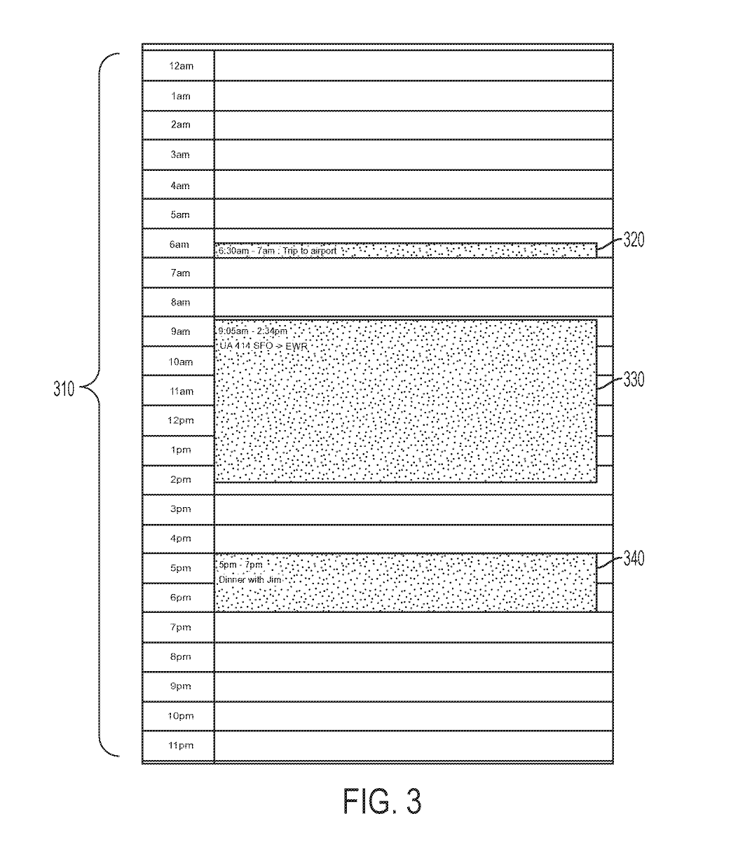

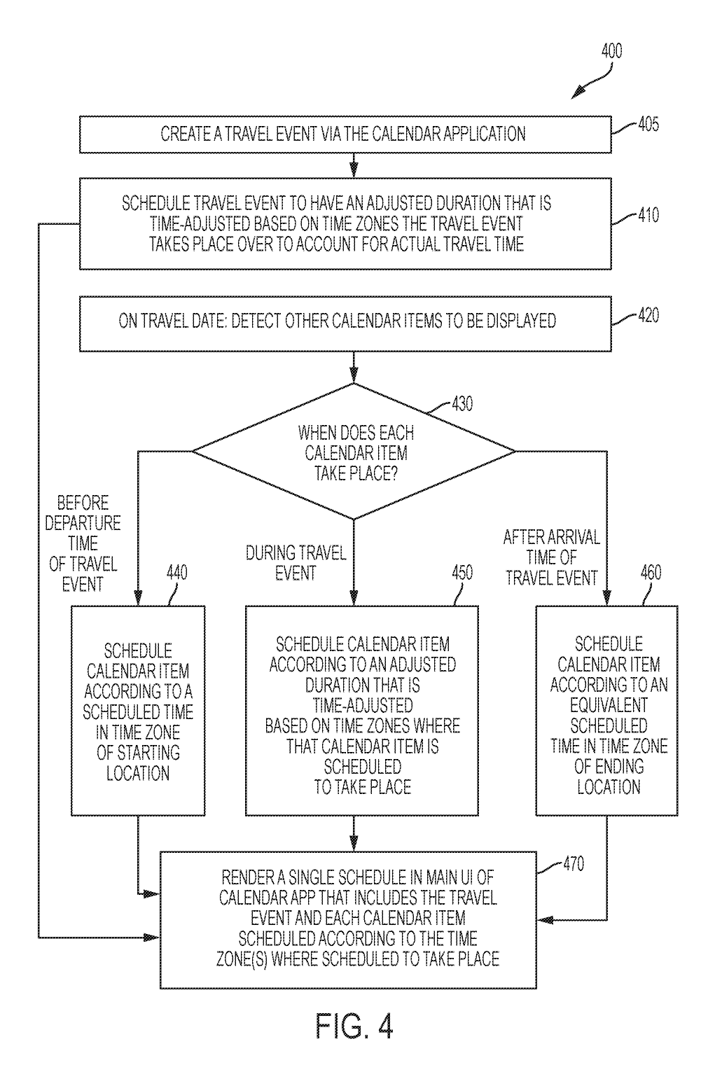

Various events or tasks performed by the various elements in FIG. 2 will be described in greater detail below with reference to FIGS. 4-7. For example, certain operations performed at or by the user system 212, the calendar application 230 and the MTZM module 232, and the database systems 220 will be described below. In that regard, FIGS. 4-7 will be described with continued reference to FIG. 2. Prior to describing FIG. 4-7, an example of a calendar view that does not reflect or account for changes in time due to travel over multiple time zones will now be described with reference to FIG. 3.

FIG. 3 is a screenshot that shows a calendar day view 300 of the main UI of a calendar application including a ruler 310 that shows a schedule timeline and three calendar items 320 . . . 340 scheduled during that day. The first calendar item 320 is a travel event titled “Trip to airport” that is scheduled from 6:30 to 7:00 AM. This corresponds to a trip to the airport in San Francisco, which is in the Pacific Standard Time (PST) zone. The second calendar item 330 is another travel event titled “UA 414 SFO→EWR” that is scheduled from 9:05 AM to 2:34 PM. This corresponds to a flight from the airport in San Francisco, which is in the PST zone, to an airport in New York, which is in the Eastern Standard Time (EST) zone. The EST zone is three hours ahead the PST Zone (e.g., the EST zone “leads” the PST Zone by three hours ahead). The third calendar item 340 is a meeting event titled “Dinner with Jim” that is scheduled from 5:00 PM to 7:00 PM in New York, which is in the EST zone and three hours ahead the PST Zone that the user is located in at the start of the day.

One problem with the calendar view that is shown in FIG. 3 is that the calendar view shows a schedule in which the travel event ends at 2:34 PM. This calendar event 330 is locked in the PST zone, and does not reflect or account for changes in time due to travel over multiple time zones. Thus, although the real duration of the trip is scheduled to be 5 hours 29 minutes, when the user arrives in New York 8 hours 29 minutes have passed when travel over the different time zones is accounted for. The second calendar item 330 does not provide any clear visual indication that this is the case. In addition, the calendar view that is shown in FIG. 3 shows the third calendar item 340 taking place at the wrong time in New York. The third calendar item 340 shows up three hours too early since it will actually be taking place from 8:00 PM to 10:00 PM in the EST zone where New York is located.

The calendar view of FIG. 3 shows a schedule that is defined within a 24 hour window that is set in terms of the time zone (PST zone) of origin where the user's travel started. The 24 hour day view is not adapted, and the schedule that is displayed does not reflect that the user would lose some hours during the day. In other words, the schedule that is displayed is not adjusted or adapted to reflect the actual time frames or durations when the calendar items 330, 340 take place in the time zones where they are occurring. To address these issues, the disclosed embodiments can provide a calendar application that provides multiple time zone calendar views during travel between time zones as will now be described with reference to FIGS. 4-7.

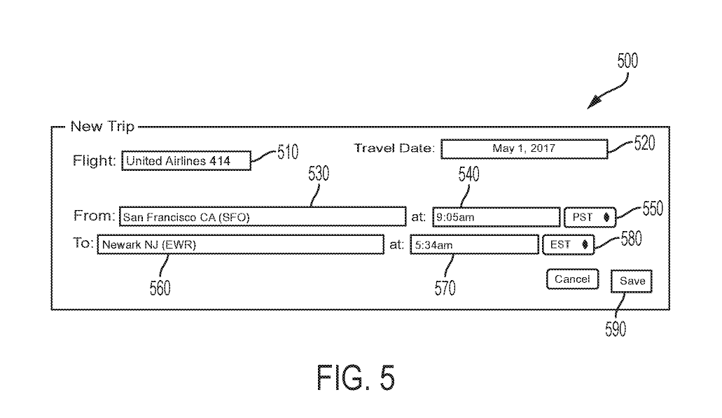

FIG. 4 is a flow chart that illustrates an exemplary method 400 for generating a calendar view of a schedule that includes time zone adjusted calendar items in accordance with the disclosed embodiments. The method 400 will be described below with continued reference to FIG. 2, and with reference to FIGS. 5-7.

It should be understood that steps of the method 400 are not necessarily limiting, and that steps can be added, omitted, and/or performed simultaneously without departing from the scope of the appended claims. It should be appreciated that the method 400 may include any number of additional or alternative tasks, that the tasks shown in FIG. 4 need not be performed in the illustrated order, and that the method 400 may be incorporated into a more comprehensive procedure or process having additional functionality not described in detail herein. Moreover, one or more of the tasks shown in FIG. 4 could potentially be omitted from an embodiment of the method 400 as long as the intended overall functionality remains intact. It should also be understood that the illustrated method 400 can be stopped at any time, for example, by disabling or cancelling it. The method 400 is computer-implemented in that various tasks or steps that are performed in connection with the method 400 may be performed by software, hardware, firmware, or any combination thereof. For illustrative purposes, the following description of the method 400 may refer to elements mentioned above in connection with FIG. 2. In certain embodiments, some or all steps of this process, and/or substantially equivalent steps, are performed by execution of processor-readable instructions stored or included on a processor-readable medium. For instance, in the description of FIG. 4 that follows, the cloud-based computing platform 200, the application platform 210, the user system 212, the database system(s) 220, the calendar application 230 and the MTZM module 232 can be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of server systems that work together. Furthermore, in the description of FIG. 4, a particular example is described in which a user of a user system performs certain actions by interacting with other elements of the system via the user system 212.

The method 400 begins at 405, where a user of the calendar application 230 creates a travel event on a calendar. The user can do so by inputting travel information into the calendar application about the travel event. The travel information that is input varies depending on the implementation. For instance, in one implementation, a user can use a travel event creation element 500 like the one illustrated in FIG. 5 to create the travel event.

As shown in FIG. 5, the user can use the travel event creation element 500 to input travel information that includes a travel identifier 510 (e.g., airline and flight number); a travel date 520, a starting location 530, a departure time 540, the time zone 550 of the departure or starting location, a destination or ending location 560, an arrival time 570, the time zone 580 of the ending location. Once the user has input all of the information, the user can select the save button 590 to complete creation of the travel event. Alternatively, if the user no longer wishes to create the travel event, the user can select the cancel button (not labeled) to cancel the creation of the travel event. In one embodiment, the user manually enters all of the information shown in FIG. 5. In another embodiment, the user can simply input or select a travel identifier 510 (e.g., airline and flight number) and travel date 520, and the calendar application will automatically query a service to retrieve all of the other required information need for the various fields 530 . . . 580 and then auto-populate the various fields 530 . . . 580 for the user. The user can then save to create the travel event. The travel event is a special type of calendar item. The travel event has a starting location in a time zone of origin that the user departs from at a departure time, and an ending location in a different time zone that the user arrives at an arrival time. As such, the starting location and the ending location span more than one time zone.

At 410, the MTZM module 232 of the calendar application 230 schedules the travel event to have an adjusted duration. For example, the MTZM module 232 of the calendar application 230 can compute an adjusted duration for the travel event that is time-adjusted based on the time zones the travel event takes place over, and schedule the travel event to have the adjusted duration. In other words, this adjusted duration is time-adjusted, based on the time zones that the travel event takes place over, to reflect or account for actual travel time (e.g., account for the user's travel between time zones) and thereby provide a clear visual indication that the user will be switching between and crossing the time zones during the course of the travel event. As such, the adjusted duration for the travel event that is time-adjusted to reflect a relevant time period as perceived by the user taking into account any time lost when the time zone of the ending location (e.g., San Francisco) lags the time zone of the starting location (e.g., NY), and taking into account any time gained when the time zone of the ending location (e.g., NY) leads the time zone of the starting location (e.g., San Francisco). Thus, the adjusted duration reflects or models real time travelled between the time zones and provides a calendar view that reflects the actual duration of the travel event as the user experiences the travel event as opposed to a view that is tied to the time zone of origin at the starting location.

The schedule of other calendar items can be updated on a regular basis (e.g., according to a predetermined schedule or expiration of a time period). Alternatively, the schedule of other calendar items can be updated in response to creation of a new calendar item, or in response to edit a calendar item, or in response to certain triggers, such as whenever the calendar application is opened, closed, or updated with new calendar items.

At 420, the MTZM module 232 of the calendar application 230 detects all other calendar items that are scheduled to be displayed (in the main UI of the calendar application) on the day of the travel event, and determines, at 430, when each calendar item should be scheduled to take place relative to the time of the travel event so that the duration and timing of certain calendar items can be adjusted (if necessary). Each calendar item can be scheduled to either occur before the departure time that is scheduled for the travel event, during the travel event, or after arrival time that is scheduled for the travel event.

For any calendar items are scheduled to take place before the departure time of the travel event, the method proceeds to 440, where the MTZM module 232 schedules the calendar item according to a scheduled time in the time zone of origin, which is the starting location of the travel event. In other words, the MTZM module 232 schedules each “preceding” calendar item that is scheduled to take place before the departure time of the travel event according to a scheduled time in the time zone of origin where that preceding calendar item is scheduled to take place. As such, there is no change in the way such preceding calendar items are scheduled and displayed within the main UI of the calendar application.

For any calendar items are scheduled to take place during the travel event, at 450, the MTZM module 232 schedules those calendar items according to an adjusted duration that is time adjusted based on time zones where that calendar item is scheduled to take place. In other words, for each calendar item that is scheduled to take place during the travel event, the MTZM module 232 can compute an adjusted duration that is time-adjusted based on the time zones where that calendar item is scheduled to take place during the travel event, and schedule each of those calendar items according to the adjusted duration of that calendar item such that each calendar item is time-adjusted based on one or more time zones where that calendar item is scheduled to take place. For example, the adjusted duration for the travel event can be time-adjusted to start at the departure time in the first time zone and end at the arrival time in the second time zone. This way, the travel event is scheduled over a time range that reflects the departure time in the first time zone and the arrival time in the second time zone to provide an adjusted view of the calendar. The adjusted view of the calendar takes into account travel between time zones during travel event including either time lost when the time zone of the ending location lags the time zone of the starting location, or time gained when the time zone of the ending location leads the time zone of the starting location.

For any calendar items that are scheduled to take place after the arrival time of the travel event, at 460, the MTZM module 232 schedules those calendar items according to an equivalent scheduled time in the time zone of the ending location where the travel event ends. In other words, the MTZM module 232 schedules each “subsequent” calendar item, that is scheduled to take place after the arrival time of the travel event, so that each subsequent calendar item is time-adjusted to an equivalent scheduled time in the destination time zone where that subsequent calendar item is scheduled to take place so that each subsequent calendar item can be displayed so that it is time-adjusted according to the equivalent schedule time meaning that its duration is adjusted so that it is displayed in terms of time in the destination time zone.

After all the calendar items to been processed to determine how they should be scheduled on the main calendar UI, at 470, the MTZM module 232 renders a single schedule that is displayed in the main UI of the calendar application. The single schedule is for at least a portion of day and includes the travel event and each of the calendar items scheduled according to the time zones where they are scheduled to take place. In other words, the travel event is time-adjusted based on the time zones that the travel event takes place over such that the travel event is rendered within the schedule to have the adjusted duration (as described above). In addition, any calendar items that were determined to be taking place over two or more time zones are rendered within the schedule using the adjusted durations for those calendar items, and any calendar items that were determined to be taking place after arrival at the destination time zone are rendered within the schedule according to an equivalent scheduled time in the destination time zone of the ending location where the travel event ends.

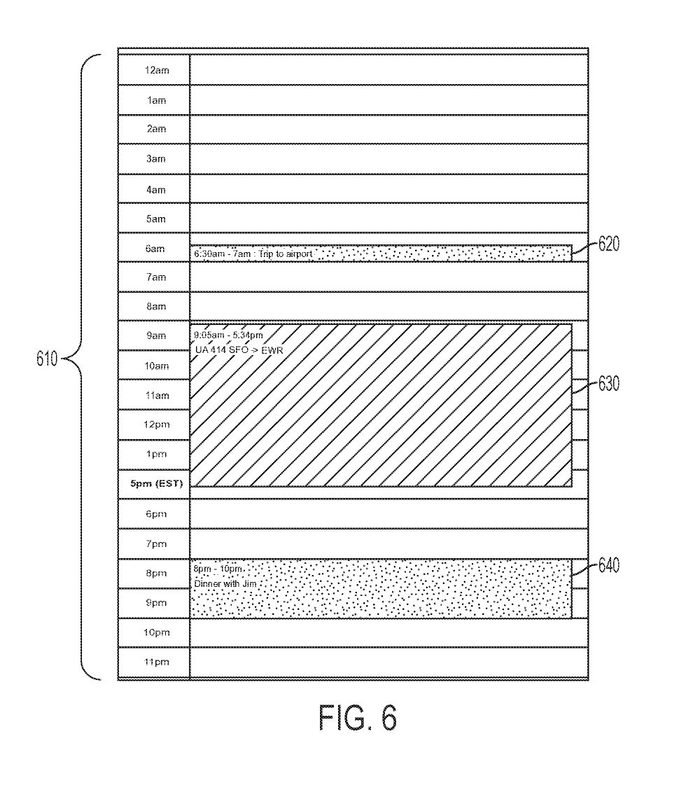

FIG. 6 is a screenshot that shows an adjusted calendar day view 600 of the main UI of a calendar application including a ruler 610 that shows an adjusted schedule timeline and three calendar items 620 . . . 640 scheduled during a day. The calendar items correspond to those shown in FIG. 3, but here the MTZM module 232 has scheduled the calendar items 620 . . . 630 (in a single schedule presented on the main calendar UI) according to the time zones where they are scheduled to take place. In other words, FIG. 6 shows the adjusted calendar view 600 after the MTZM module 232 has adjusted the duration of the second and third calendar items 330, 340 from FIG. 3 as indicted by the timing or adjusted durations of the second and third calendar items 630, 640.

The first calendar item 620 is a travel event titled “Trip to airport” that is scheduled from 6:30 to 7:00 AM. This corresponds to a trip to the airport in San Francisco, which is in the Pacific Standard Time (PST) zone. Because the first calendar item 620 is scheduled to take place before the scheduled departure time of the travel event, the MTZM module 232 schedules the first calendar item 620 according to a scheduled time in the time zone of origin (PST zone), which is the starting location of the travel event. As such, the first calendar item 620 is rendered within the schedule that is presented on the main UI of the calendar application at the times (6:30 to 7:00 AM) it will occur in the time zone of origin (PST zone).

The second calendar item 630 is another travel event titled “UA 414 SFO→EWR” that corresponds to a flight from the airport (SFO) in San Francisco, which is in the PST zone, to an airport (EWO) in New York, which is in the Eastern Standard Time (EST) zone. The EST zone is three hours ahead the PST Zone (e.g., the EST zone “leads” or is “ahead of” the PST zone by three hours). Because the second calendar item 630 is a travel event that spans multiple time zones, and is scheduled to take place over multiple time zones, the MTZM module 232 schedules the travel event according to an adjusted duration that is time adjusted based on time zones where the travel event is scheduled to take place. As such, the second calendar item 630 is rendered within the schedule that is presented on the main UI of the calendar application at the times it will occur starting with a scheduled departure time (9:05 AM) in the time zone of origin (PST zone), and ending with a scheduled arrival time (5:34 PM) in the destination time zone (EST zone). To explain further, in the adjusted calendar view, the second calendar item 630 is scheduled from 9:05 AM to 5:34 PM, but is still shown as covering a time block having a duration of 5 hours and 29 minutes to reflect the actual time spent traveling event though time zones have been crossed during the travel event. This results in a day view that is less than 24 hours (e.g., the user's day is now 21 hours with travel from CA to NY taken into account).

As illustrated in FIG. 6, the time block that is used to mark the second calendar item 630 on the schedule can be shown in a different color and/or shading than other calendar items 620, 640 that do not cross over multiple time zones to differentiate the travel event from other calendar items that do not occur over different time zones. In addition, the vertical ruler 610 can show the hours of the day with an indication that clearly indicates that a time zone change has occurred. In the non-limiting example shown in FIG. 6, the hour during which the arrival time occurs can be displayed in bold characters that have a different color in terms of the time in the destination time zone to reflect that a time zone change has occurred during travel. As such, in this example, the vertical ruler 610 shows the hour during which the arrival time occurs as 5 PM (EST) instead of 8 PM (EST). For instance, in one implementation, the hour during which the arrival time occurs can be displayed as 5 PM (EST), where 5 PM (EST) is shown in bold, red font to distinguish it from other hour times that are displayed in the vertical ruler 610.

In addition, all hours in the vertical ruler 610 that occur after 5 PM (EST) are adjusted accordingly to reflect the time in the EST zone. This way any calendar items that happen after the time zone transition correctly reflect the time in the new time zone (EST zone). For example, in FIG. 6, the third calendar item 640 is a meeting event titled “Dinner with Jim” that is scheduled from 8:00 PM to 10:00 PM in New York, which is in the EST zone and three hours ahead the time zone of origin (PST Zone) that the user was located in at the start of the travel event. Because the third calendar item 640 is scheduled to take place after the arrival time of the travel event 630, the MTZM module 232 schedules the third calendar item 640 to have an adjusted duration or timing that is time adjusted based on time zone where the third calendar item 640 is scheduled to take place. In other words, the MTZM module 232 schedules the third calendar item 640 according to an equivalent scheduled time in the time zone (EST zone) of the ending location (e.g., where the travel event 640 ends). This way the user has a clearer visual representation regarding when the third calendar item 640 actually takes place in the context to the adjusted day view that shows timing of the item 640 in the time zone where it actually occurs.

Although not illustrated in FIG. 6, the adjusted calendar view 600 could also include other information that would be helpful to the user in making decisions. For instance, the adjusted calendar view 600 could also include additional information that is important to the user, such as time zone conversions. So in this example, when the user lands in New York, the adjusted calendar view 600 could include information indicating the time in the time zone of origin (e.g., indicating that it is still 2:34 pm in San Francisco).

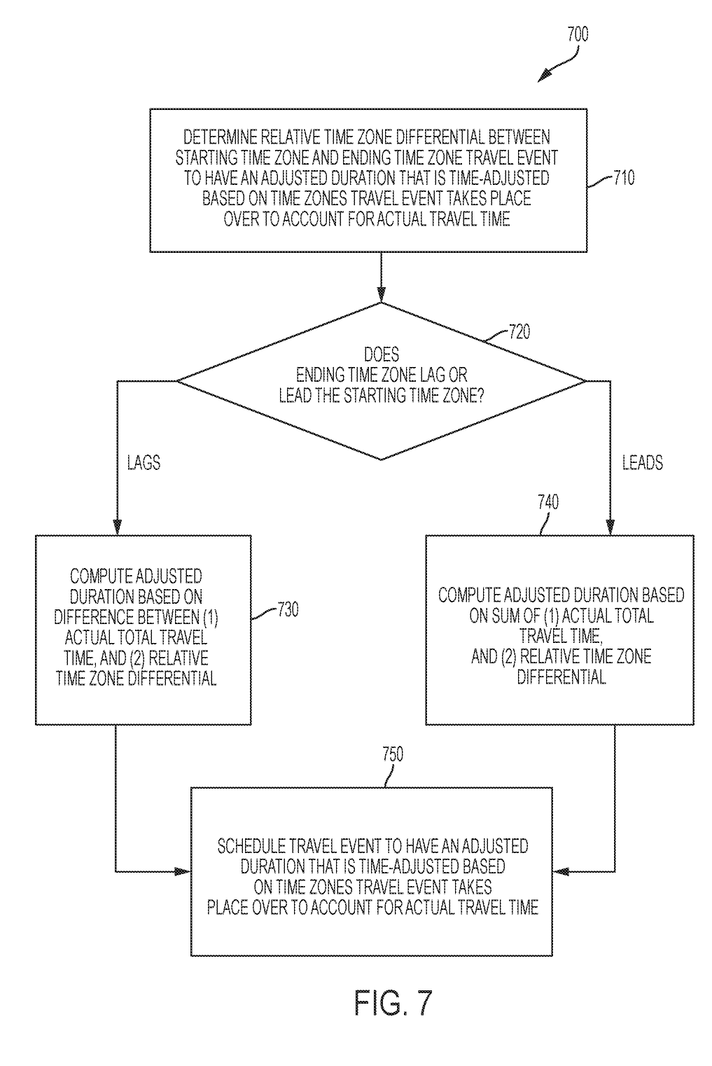

FIG. 7 is a flow chart that illustrates an exemplary method 700 for computing an adjusted duration for a travel event or other calendar item in accordance with the disclosed embodiments. In other words, the steps of the method 700 can be used to perform, for example, steps 410 and 450 of FIG. 4. As noted above with respect to FIG. 4, for any travel event or any calendar items that are scheduled to take place during a travel event, the MTZM module 232 schedules those calendar items according to an adjusted duration that is time adjusted based on time zones where they are scheduled to take place during the travel event by computing an adjusted duration. For sake of simplicity, the method 700 will be described with reference to a travel event, but it should be appreciated that the method 700 can also be applied to schedule adjusted durations for any calendar items that are scheduled to take place during the course of a travel event.

In addition, it should be understood that steps of the method 700 are not necessarily limiting, and that steps can be added, and therefore, the method 700 may include any number of additional or alternative tasks. Furthermore, the tasks shown in FIG. 7 need not be performed in the illustrated order, and the method 700 may be incorporated into a more comprehensive procedure or process having additional functionality not described in detail herein. Moreover, one or more of the tasks shown in FIG. 7 could potentially be omitted from an embodiment of the method 700 as long as the intended overall functionality remains intact. It should also be understood that the illustrated method 700 is computer-implemented in that various tasks or steps that are performed in connection with the method 700 may be performed by software, hardware, firmware, or any combination thereof. For illustrative purposes, the following description of the method 700 may refer to elements mentioned above in connection with FIG. 2. In certain embodiments, some or all steps of this process, and/or substantially equivalent steps, are performed by execution of processor-readable instructions stored or included on a processor-readable medium. For instance, in the description of FIG. 7 that follows, the MTZM module 232 of the calendar application 230 can be described as performing various acts, tasks or steps, but it should be appreciated that this refers to processing system(s) executing instructions to perform those various acts, tasks or steps.

The method 700 begins at 710, where the MTZM module 232 determines a relative time zone differential between a time zone of origin at the starting location of the travel event and a destination time zone at the ending location of the travel event. The relative time zone differential is the time offset between the time zones, or absolute value of the time difference between the time zones.

At 720, the MTZM module 232 determines whether the destination time zone lags or leads the time zone of origin. Depending on the direction the user is traveling, the calendar day view that is displayed can have a duration that is less than 24 hours when the destination time zone leads the time zone of origin because the user loses time when traveling across time zones, or greater than 24 hours when the destination time zone lags the time zone of origin because the user gains time when traveling across time zones.

When the MTZM module 232 determines that the destination time zone lags the time zone of origin, the method 700 proceeds to 730, where the MTZM module 232 computes the adjusted duration of the travel event based on the difference between (1) an actual total travel time between the ending location and the starting location, and (2) the relative time zone differential. For example, when the anticipated time of departure is 6:00 AM from the starting location is (NY, N.Y.) and the anticipated time of arrival is 9:00 AM at the ending location (San Francisco, Calif.), the relative time zone differential is three hours. In this case the time zone of CA (ending location) lags the time zone of NY (starting location) by −3 hours. The actual duration of the travel event, which is 6 hours, will be adjusted on the calendar to reflect an adjusted duration of the calendar item for the travel event, which will be three hours even though the actual duration of the flight is six hours.

In one non-limiting embodiment, the actual total travel time between the ending location and the starting location is the travel time between an anticipated arrival of the user at the ending location and an anticipated departure of the user from the starting location. This embodiment assumes that the anticipated travel plans will proceed as originally scheduled.

However, in other embodiments, the actual total travel time can be computed in real-time based on updated data from other services (e.g., a cellular or satellite based service that monitors the user's location in real-time) regarding the estimated departure time of the user from the starting location and the estimated arrival of the user at the ending location.

Referring again to FIG. 7, when the MTZM module 232 determines that the destination time zone leads the time zone of origin, the method 700 proceeds to 740, where the MTZM module 232 computes the adjusted duration for the travel event based on the sum of (1) an actual total travel time between the ending location and the starting location, and (2) the relative time zone differential. For example, when the anticipated time of departure is 9:05 AM from the starting location is (San Francisco, Calif.) and the anticipated time of arrival is 5:34 PM at the ending location (NY, N.Y.), the relative time zone differential is three hours. In this case the time zone of NY (ending location) leads the time zone of SF (starting location) by +3 hours. As such, the actual duration of the travel event, which is five hours and 29 minutes, will be adjusted on the calendar to reflect an adjusted duration of the travel event, which will be eight hours and 29 minutes even though the actual duration of the flight is five hours and 29 minutes.

At 750, the MTZM module 232 of the calendar application 230 can schedule the travel event to have the adjusted duration for the travel event that was computed (at 730 or 740) such that that the scheduling the of the travel event is time-adjusted based on the time zones the travel event takes place over.

The following description is of one example of a system in which the features described above may be implemented. The components of the system described below are merely one example and should not be construed as limiting. The features described above with respect to FIGS. 1-7 may be implemented in any other type of computing environment, such as one with multiple servers, one with a single server, a multi-tenant server environment, a single-tenant server environment, or some combination of the above.

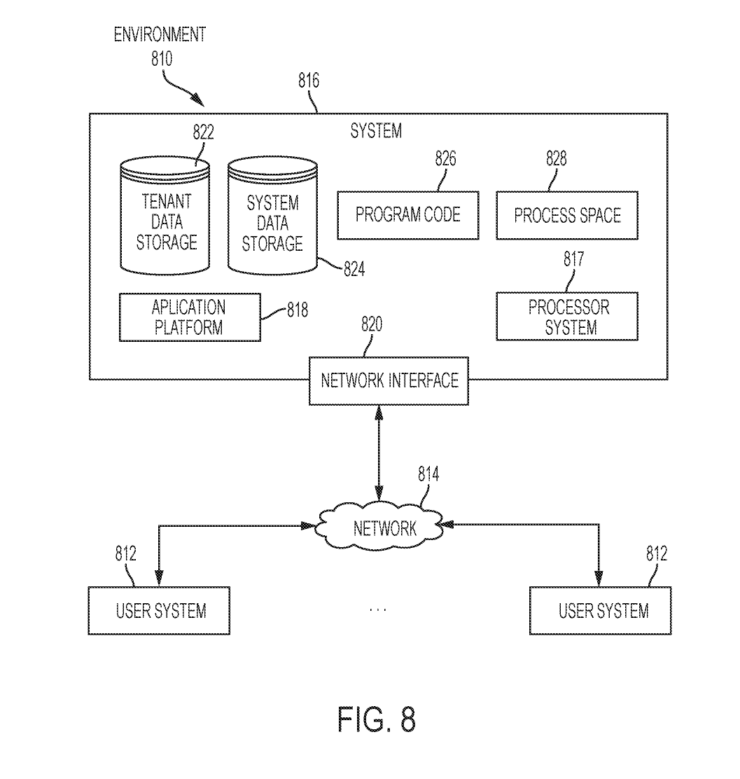

FIG. 8 shows a block diagram of an example of an environment 810 in which an on-demand database service can be used in accordance with some implementations. The environment 810 includes user systems 812, a network 814, a database system 816 (also referred to herein as a “cloud-based system”), a processor system 817, an application platform 818, a network interface 820, tenant database 822 for storing tenant data 823, system database 824 for storing system data 825, program code 826 for implementing various functions of the system 816, and process space 828 for executing database system processes and tenant-specific processes, such as running applications as part of an application hosting service. In some other implementations, environment 810 may not have all of these components or systems, or may have other components or systems instead of, or in addition to, those listed above.

In some implementations, the environment 810 is an environment in which an on-demand database service exists. An on-demand database service, such as that which can be implemented using the system 816, is a service that is made available to users outside of the enterprise(s) that own, maintain or provide access to the system 816. As described above, such users generally do not need to be concerned with building or maintaining the system 816. Instead, resources provided by the system 816 may be available for such users' use when the users need services provided by the system 816; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 818 can be a framework that allows the applications of system 816 to execute, such as the hardware or software infrastructure of the system 816. In some implementations, the application platform 818 enables the creation, management and execution of one or more applications developed by the provider of the on-demand database service, users accessing the on-demand database service via user systems 812, or third party application developers accessing the on-demand database service via user systems 812.

In some implementations, the system 816 implements a web-based customer relationship management (CRM) system. For example, in some such implementations, the system 816 includes application servers configured to implement and execute CRM software applications as well as provide related data, code, forms, renderable web pages and documents and other information to and from user systems 812 and to store to, and retrieve from, a database system related data, objects, and Web page content. In some MTS implementations, data for multiple tenants may be stored in the same physical database object in tenant database 822. In some such implementations, tenant data is arranged in the storage medium(s) of tenant database 822 so that data of one tenant is kept logically separate from that of other tenants so that one tenant does not have access to another tenant's data, unless such data is expressly shared. The system 816 also implements applications other than, or in addition to, a CRM application. For example, the system 816 can provide tenant access to multiple hosted (standard and custom) applications, including a CRM application. User (or third party developer) applications, which may or may not include CRM, may be supported by the application platform 818. The application platform 818 manages the creation and storage of the applications into one or more database objects and the execution of the applications in one or more virtual machines in the process space of the system 816.

According to some implementations, each system 816 is configured to provide web pages, forms, applications, data and media content to user (client) systems 812 to support the access by user systems 812 as tenants of system 816. As such, system 816 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 814 can be or include any network or combination of networks of systems or devices that communicate with one another. For example, the network 814 can be or include any one or any combination of a LAN (local area network), WAN (wide area network), telephone network, wireless network, cellular network, point-to-point network, star network, token ring network, hub network, or other appropriate configuration. The network 814 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 812 can communicate with system 816 using TCP/IP and, at a higher network level, other common Internet protocols to communicate, such as HTTP, FTP, AFS, WAP, etc. In an example where HTTP is used, each user system 812 can include an HTTP client commonly referred to as a “web browser” or simply a “browser” for sending and receiving HTTP signals to and from an HTTP server of the system 816. Such an HTTP server can be implemented as the sole network interface 820 between the system 816 and the network 814, but other techniques can be used in addition to or instead of these techniques. In some implementations, the network interface 820 between the system 816 and the network 814 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 812 can be implemented as any computing device(s) or other data processing apparatus or systems usable by users to access the database system 816. For example, any of user systems 812 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 812 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 816) of the user system 812 to access, process and view information, pages and applications available to it from the system 816 over the network 814.

Each user system 812 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 812 in conjunction with pages, forms, applications and other information provided by the system 816 or other systems or servers. For example, the user interface device can be used to access data and applications hosted by system 816, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 812 may differ in their respective capacities, and the capacity of a particular user system 812 can be entirely determined by permissions (permission levels) for the current user of such user system. For example, where a salesperson is using a particular user system 812 to interact with the system 816, that user system can have the capacities allotted to the salesperson. However, while an administrator is using that user system 812 to interact with the system 816, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 812 and some or all of its components are operator-configurable using applications, such as a browser, including computer code executed using a central processing unit (CPU) such as an Intel Pentium® processor or the like. Similarly, the system 816 (and additional instances of an MTS, where more than one is present) and all of its components can be operator-configurable using application(s) including computer code to run using the processor system 817, which may be implemented to include a CPU, which may include an Intel Pentium® processor or the like, or multiple CPUs.

The system 816 includes tangible computer-readable media having non-transitory instructions stored thereon/in that are executable by or used to program a server or other computing system (or collection of such servers or computing systems) to perform some of the implementation of processes described herein. For example, computer program code 826 can implement instructions for operating and configuring the system 816 to intercommunicate and to process web pages, applications and other data and media content as described herein. In some implementations, the computer code 826 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

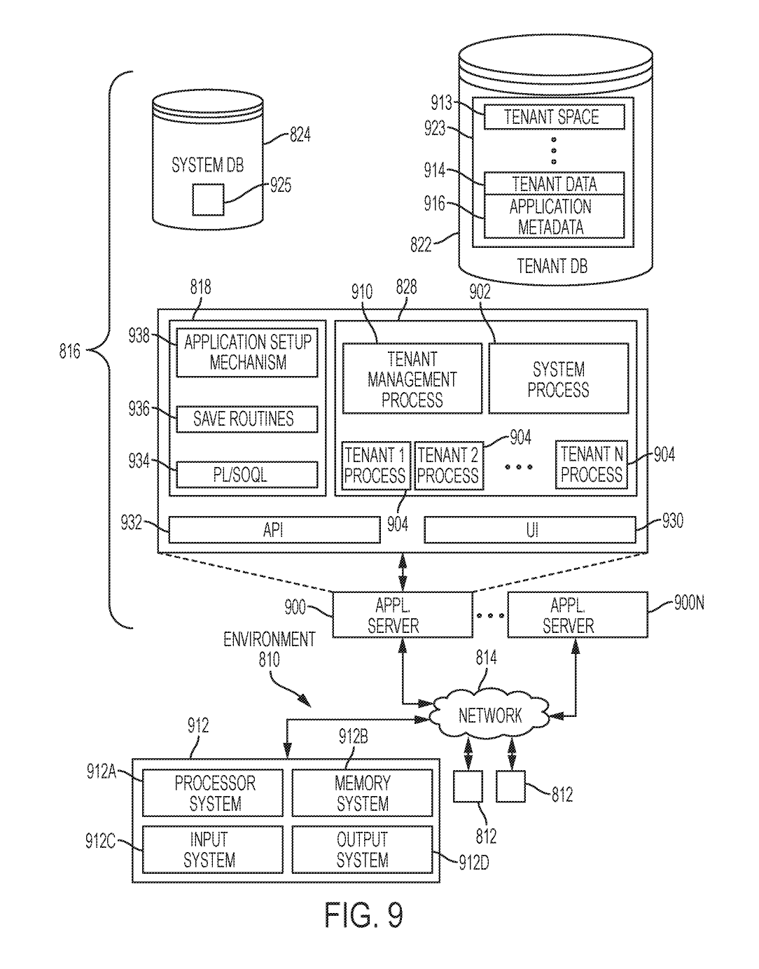

FIG. 9 shows a block diagram of example implementations of elements of FIG. 8 and example interconnections between these elements according to some implementations. That is, FIG. 9 also illustrates environment 810, but FIG. 9, various elements of the system 816 and various interconnections between such elements are shown with more specificity according to some more specific implementations. Elements from FIG. 8 that are also shown in FIG. 9 will use the same reference numbers in FIG. 9 as were used in FIG. 8. Additionally, in FIG. 9, the user system 812 includes a processor system 912A, a memory system 912B, an input system 912C, and an output system 912D. The processor system 912A can include any suitable combination of one or more processors. The memory system 912B can include any suitable combination of one or more memory devices. The input system 912C can include any suitable combination of input devices, such as one or more touchscreen interfaces, keyboards, mice, trackballs, scanners, cameras, or interfaces to networks. The output system 912D can include any suitable combination of output devices, such as one or more display devices, printers, or interfaces to networks.

In FIG. 9, the network interface 820 of FIG. 8 is implemented as a set of HTTP application servers 900₁-1400_{N}. Each application server 900, also referred to herein as an “app server,” is configured to communicate with tenant database 822 and the tenant data 923 therein, as well as system database 824 and the system data 925 therein, to serve requests received from the user systems 912. The tenant data 923 can be divided into individual tenant storage spaces 913, which can be physically or logically arranged or divided. Within each tenant storage space 913, tenant data 914 and application metadata 916 can similarly be allocated for each user. For example, a copy of a user's most recently used (MRU) items can be stored to user storage 914. Similarly, a copy of MRU items for an entire organization that is a tenant can be stored to tenant storage space 913.

The process space 828 includes system process space 902, individual tenant process spaces 904 and a tenant management process space 910. The application platform 818 includes an application setup mechanism 938 that supports application developers' creation and management of applications. Such applications and others can be saved as metadata into tenant database 822 by save routines 936 for execution by subscribers as one or more tenant process spaces 904 managed by tenant management process 910, for example. Invocations to such applications can be coded using PL/SOQL 934, which provides a programming language style interface extension to API 932. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 816 for the subscriber making the invocation and executing the metadata as an application in a virtual machine.

The system 816 of FIG. 9 also includes a user interface (UI) 930 and an application programming interface (API) 932 to system 816 resident processes to users or developers at user systems 912. In some other implementations, the environment 810 may not have the same elements as those listed above or may have other elements instead of, or in addition to, those listed above.

Each application server 900 can be communicably coupled with tenant database 822 and system database 824, for example, having access to tenant data 923 and system data 925, respectively, via a different network connection. For example, one application server 900₁ can be coupled via the network 814 (for example, the Internet), another application server 900_{N} can be coupled via a direct network link, and another application server (not illustrated) can be coupled by yet a different network connection. Transfer Control Protocol and Internet Protocol (TCP/IP) are examples of typical protocols that can be used for communicating between application servers 900 and the system 816. However, it will be apparent to one skilled in the art that other transport protocols can be used to optimize the system 816 depending on the network interconnections used.

In some implementations, each application server 900 is configured to handle requests for any user associated with any organization that is a tenant of the system 816. Because it can be desirable to be able to add and remove application servers 900 from the server pool at any time and for various reasons, in some implementations there is no server affinity for a user or organization to a specific application server 900. In some such implementations, an interface system implementing a load balancing function (for example, an F5 Big-IP load balancer) is communicably coupled between the application servers 900 and the user systems 912 to distribute requests to the application servers 900. In one implementation, the load balancer uses a least-connections algorithm to route user requests to the application servers 900. Other examples of load balancing algorithms, such as round robin and observed-response-time, also can be used. For example, in some instances, three consecutive requests from the same user could hit three different application servers 900, and three requests from different users could hit the same application server 900. In this manner, by way of example, system 816 can be a multi-tenant system in which system 816 handles storage of, and access to, different objects, data and applications across disparate users and organizations.

In one example storage use case, one tenant can be a company that employs a sales force where each salesperson uses system 816 to manage aspects of their sales. A user can maintain contact data, leads data, customer follow-up data, performance data, goals and progress data, etc., all applicable to that user's personal sales process (for example, in tenant database 822). In an example of a MTS arrangement, because all of the data and the applications to access, view, modify, report, transmit, calculate, etc., can be maintained and accessed by a user system 912 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 816 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 816 also can maintain system level data usable by multiple tenants or other data. Such system level data can include industry reports, news, postings, and the like that are sharable among tenants.

In some implementations, the user systems 912 (which also can be client systems) communicate with the application servers 900 to request and update system-level and tenant-level data from the system 816. Such requests and updates can involve sending one or more queries to tenant database 822 or system database 824. The system 816 (for example, an application server 900 in the system 816) can automatically generate one or more SQL statements (for example, one or more SQL queries) designed to access the desired information. System database 824 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

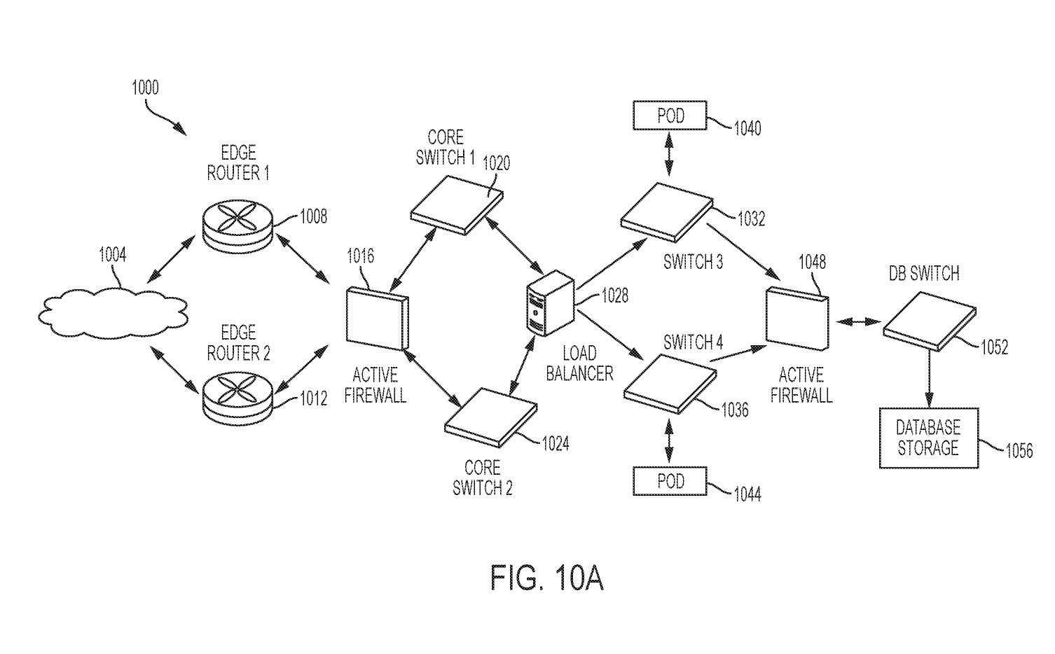

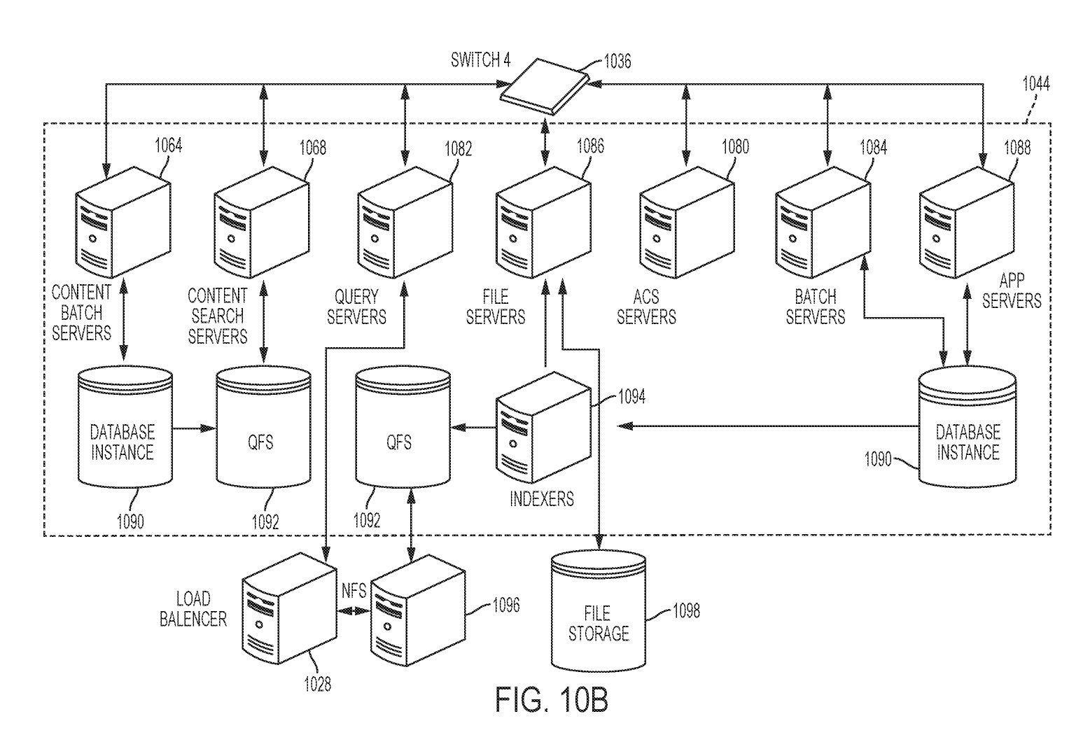

FIG. 10A shows a system diagram illustrating example architectural components of an on-demand database service environment 1000 according to some implementations. A client machine communicably connected with the cloud 1004, generally referring to one or more networks in combination, as described herein, can communicate with the on-demand database service environment 1000 via one or more edge routers 1008 and 1012. A client machine can be any of the examples of user systems 12 described above. The edge routers can communicate with one or more core switches 1020 and 1024 through a firewall 1016. The core switches can communicate with a load balancer 1028, which can distribute server load over different pods, such as the pods 1040 and 1044. The pods 1040 and 1044, which can each include one or more servers or other computing resources, can perform data processing and other operations used to provide on-demand services. Communication with the pods can be conducted via pod switches 1032 and 1036. Components of the on-demand database service environment can communicate with database storage 1056 through a database firewall 1048 and a database switch 1052.

As shown in FIGS. 10A and 10B, accessing an on-demand database service environment can involve communications transmitted among a variety of different hardware or software components. Further, the on-demand database service environment 1000 is a simplified representation of an actual on-demand database service environment. For example, while only one or two devices of each type are shown in FIGS. 10A and 10B, some implementations of an on-demand database service environment can include anywhere from one to several devices of each type. Also, the on-demand database service environment need not include each device shown in FIGS. 10A and 10B, or can include additional devices not shown in FIGS. 10A and 10B.

Additionally, it should be appreciated that one or more of the devices in the on-demand database service environment 1000 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 1004 is intended to refer to a data network or multiple data networks, often including the Internet. Client machines communicably connected with the cloud 1004 can communicate with other components of the on-demand database service environment 1000 to access services provided by the on-demand database service environment. For example, client machines can access the on-demand database service environment to retrieve, store, edit, or process information. In some implementations, the edge routers 1008 and 1012 route packets between the cloud 1004 and other components of the on-demand database service environment 1000. For example, the edge routers 1008 and 1012 can employ the Border Gateway Protocol (BGP). The BGP is the core routing protocol of the Internet. The edge routers 1008 and 1012 can maintain a table of IP networks or ‘prefixes’, which designate network reachability among autonomous systems on the Internet.

In some implementations, the firewall 1016 can protect the inner components of the on-demand database service environment 1000 from Internet traffic. The firewall 1016 can block, permit, or deny access to the inner components of the on-demand database service environment 1000 based upon a set of rules and other criteria. The firewall 1016 can act as one or more of a packet filter, an application gateway, a stateful filter, a proxy server, or any other type of firewall.

In some implementations, the core switches 1020 and 1024 are high-capacity switches that transfer packets within the on-demand database service environment 1000. The core switches 1020 and 1024 can be configured as network bridges that quickly route data between different components within the on-demand database service environment. In some implementations, the use of two or more core switches 1020 and 1024 can provide redundancy or reduced latency.

In some implementations, the pods 1040 and 1044 perform the core data processing and service functions provided by the on-demand database service environment. Each pod can include various types of hardware or software computing resources. An example of the pod architecture is discussed in greater detail with reference to FIG. 10B. In some implementations, communication between the pods 1040 and 1044 is conducted via the pod switches 1032 and 1036. The pod switches 1032 and 1036 can facilitate communication between the pods 1040 and 1044 and client machines communicably connected with the cloud 1004, for example via core switches 1020 and 1024. Also, the pod switches 1032 and 1036 may facilitate communication between the pods 1040 and 1044 and the database storage 1056. In some implementations, the load balancer 1028 can distribute workload between the pods 1040 and 1044. Balancing the on-demand service requests between the pods can assist in improving the use of resources, increasing throughput, reducing response times, or reducing overhead. The load balancer 1028 may include multilayer switches to analyze and forward traffic.

In some implementations, access to the database storage 1056 is guarded by a database firewall 1048. The database firewall 1048 can act as a computer application firewall operating at the database application layer of a protocol stack. The database firewall 1048 can protect the database storage 1056 from application attacks such as structure query language (SQL) injection, database rootkits, and unauthorized information disclosure. In some implementations, the database firewall 1048 includes a host using one or more forms of reverse proxy services to proxy traffic before passing it to a gateway router. The database firewall 1048 can inspect the contents of database traffic and block certain content or database requests. The database firewall 1048 can work on the SQL application level atop the TCP/IP stack, managing applications' connection to the database or SQL management interfaces as well as intercepting and enforcing packets traveling to or from a database network or application interface.

In some implementations, communication with the database storage 1056 is conducted via the database switch 1052. The multi-tenant database storage 1056 can include more than one hardware or software components for handling database queries. Accordingly, the database switch 1052 can direct database queries transmitted by other components of the on-demand database service environment (for example, the pods 1040 and 1044) to the correct components within the database storage 1056. In some implementations, the database storage 1056 is an on-demand database system shared by many different organizations as described above with reference to FIG. 8 and FIG. 9.

FIG. 10B shows a system diagram further illustrating example architectural components of an on-demand database service environment according to some implementations. The pod 1044 can be used to render services to a user of the on-demand database service environment 1000. In some implementations, each pod includes a variety of servers or other systems. The pod 1044 includes one or more content batch servers 1064, content search servers 1068, query servers 1082, file force servers 1086, access control system (ACS) servers 1080, batch servers 1084, and app servers 1088. The pod 1044 also can include database instances 1090, quick file systems (QFS) 1092, and indexers 1094. In some implementations, some or all communication between the servers in the pod 1044 can be transmitted via the switch 1036.

In some implementations, the app servers 1088 include a hardware or software framework dedicated to the execution of procedures (for example, programs, routines, scripts) for supporting the construction of applications provided by the on-demand database service environment 1000 via the pod 1044. In some implementations, the hardware or software framework of an app server 1088 is configured to execute operations of the services described herein, including performance of the blocks of various methods or processes described herein. In some alternative implementations, two or more app servers 1088 can be included and cooperate to perform such methods, or one or more other servers described herein can be configured to perform the disclosed methods.

The content batch servers 1064 can handle requests internal to the pod. Some such requests can be long-running or not tied to a particular customer. For example, the content batch servers 1064 can handle requests related to log mining, cleanup work, and maintenance tasks. The content search servers 1068 can provide query and indexer functions. For example, the functions provided by the content search servers 1068 can allow users to search through content stored in the on-demand database service environment. The file force servers 1086 can manage requests for information stored in the File force storage 1098. The File force storage 1098 can store information such as documents, images, and basic large objects (BLOBs). By managing requests for information using the file force servers 1086, the image footprint on the database can be reduced. The query servers 1082 can be used to retrieve information from one or more file storage systems. For example, the query system 1082 can receive requests for information from the app servers 1088 and transmit information queries to the NFS 1096 located outside the pod.

The pod 1044 can share a database instance 1090 configured as a multi-tenant environment in which different organizations share access to the same database. Additionally, services rendered by the pod 1044 may call upon various hardware or software resources. In some implementations, the ACS servers 1080 control access to data, hardware resources, or software resources. In some implementations, the batch servers 1084 process batch jobs, which are used to run tasks at specified times. For example, the batch servers 1084 can transmit instructions to other servers, such as the app servers 1088, to trigger the batch jobs.

In some implementations, the QFS 1092 is an open source file storage system available from Sun Microsystems® of Santa Clara, Calif. The QFS can serve as a rapid-access file storage system for storing and accessing information available within the pod 1044. The QFS 1092 can support some volume management capabilities, allowing many disks to be grouped together into a file storage system. File storage system metadata can be kept on a separate set of disks, which can be useful for streaming applications where long disk seeks cannot be tolerated. Thus, the QFS system can communicate with one or more content search servers 1068 or indexers 1094 to identify, retrieve, move, or update data stored in the network file storage systems 1096 or other storage systems.

In some implementations, one or more query servers 1082 communicate with the NFS 1096 to retrieve or update information stored outside of the pod 1044. The NFS 1096 can allow servers located in the pod 1044 to access information to access files over a network in a manner similar to how local storage is accessed. In some implementations, queries from the query servers 1082 are transmitted to the NFS 1096 via the load balancer 1028, which can distribute resource requests over various resources available in the on-demand database service environment. The NFS 1096 also can communicate with the QFS 1092 to update the information stored on the NFS 1096 or to provide information to the QFS 1092 for use by servers located within the pod 1044.

In some implementations, the pod includes one or more database instances 1090. The database instance 1090 can transmit information to the QFS 1092. When information is transmitted to the QFS, it can be available for use by servers within the pod 1044 without using an additional database call. In some implementations, database information is transmitted to the indexer 1094. Indexer 1094 can provide an index of information available in the database 1090 or QFS 1092. The index information can be provided to file force servers 1086 or the QFS 1092.

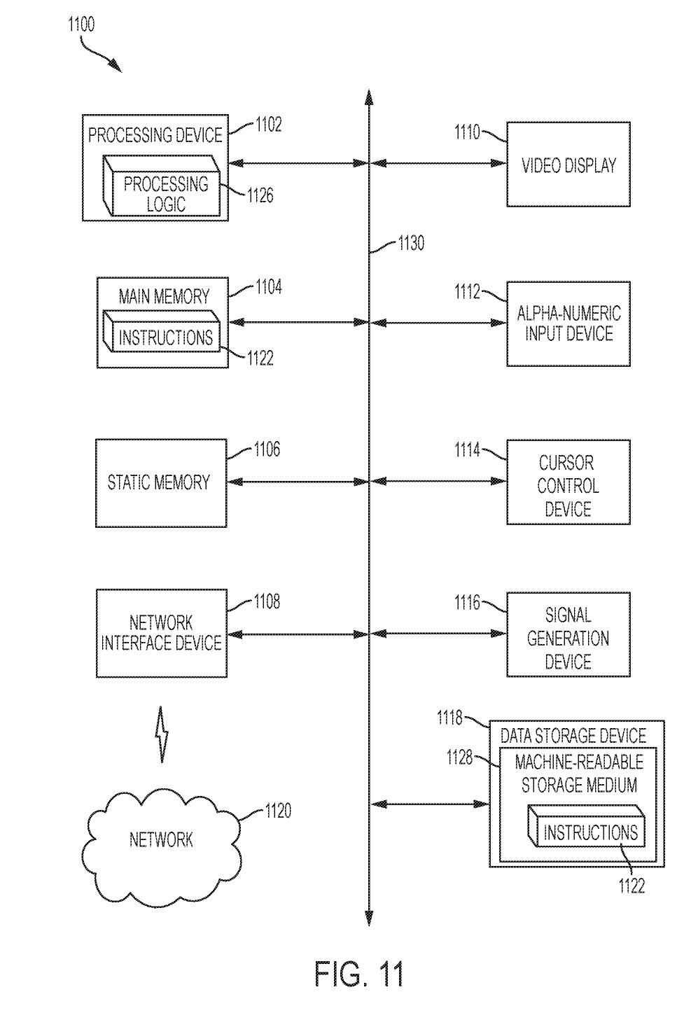

FIG. 11 illustrates a diagrammatic representation of a machine in the exemplary form of a computer system 1100 within which a set of instructions, for causing the machine to perform any one or more of the methodologies discussed herein, may be executed. The system 1100 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processing device (processor) 1102, a main memory 1104 (e.g., read-only memory (ROM), flash memory, dynamic random access memory (DRAM) such as synchronous DRAM (SDRAM)), a static memory 1106 (e.g., flash memory, static random access memory (SRAM)), and a data storage device 1118, which communicate with each other via a bus 1130.

Processing device 1102 represents one or more general-purpose processing devices such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also be one or more special-purpose processing devices such as an application specific integrated circuit (ASIC), a field programmable gate array (FPGA), a digital signal processor (DSP), network processor, or the like.

The computer system 1100 may further include a network interface device 1108. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1116 (e.g., a speaker).

The data storage device 1118 may include a computer-readable medium 1128 on which is stored one or more sets of instructions 1122 (e.g., instructions of in-memory buffer service 114) embodying any one or more of the methodologies or functions described herein. The instructions 1122 may also reside, completely or at least partially, within the main memory 1104 and/or within processing logic 1126 of the processing device 1102 during execution thereof by the computer system 1100, the main memory 1104 and the processing device 1102 also constituting computer-readable media. The instructions may further be transmitted or received over a network 1120 via the network interface device 1108.

While the computer-readable storage medium 1128 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “identifying”, “adding”, “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method, comprising:
creating a travel event on a calendar based on travel information, wherein the travel event takes place over a first time zone of a starting location that a user departs from at a departure time, and a second time zone of an ending location that the user arrives at an arrival time;
computing an adjusted duration for the travel event that is time-adjusted, based on time zones that the travel event takes place over, to account for any transitions between the time zones that occur during the travel event;
scheduling the travel event according to the adjusted duration;
detecting other calendar items that are to be displayed in a main user interface of a calendar application; and
displaying a single schedule in the main user interface of the calendar application that includes the travel event and each of the other calendar items, wherein the travel event is displayed to have the adjusted duration that is time-adjusted to account for any transitions between the time zones that occur during the travel event.

2. The method according to claim 1, wherein the adjusted duration for the travel event is time-adjusted to start at the departure time in the first time zone and end at the arrival time in the second time zone such that the travel event is scheduled over a time range that reflects the departure time in the first time zone and the arrival time in the second time zone to provide an adjusted view of the calendar that takes into account travel between time zones during travel event.

3. The method according to claim 1, wherein the adjusted duration provides an adjusted view of the calendar that reflects the actual duration of the travel event as the user travels between the time zones.

4. The method according to claim 1, wherein the adjusted duration for the travel event that take into account:
time lost when the time zone of the ending location lags the time zone of the starting location; and
time gained when the time zone of the ending location leads the time zone of the starting location.

5. The method according to claim 1, further comprising:
determining, based on travel information, whether each calendar item is scheduled to take place before the departure time of the travel event, during the travel event, or after the arrival time of the travel event;
scheduling each calendar item, that is scheduled to take place after the arrival time of the travel event, so that each calendar item is time-adjusted to an equivalent scheduled time in the second time zone where that calendar item is scheduled to take place;
wherein displaying the single schedule in the main user interface of the calendar application, further comprises:
displaying each calendar item so that it is time-adjusted according to the equivalent schedule time in the second time zone where that calendar item is scheduled to take place.

6. The method according to claim 1, further comprising:
determining, based on travel information, whether each calendar item is scheduled to take place before the departure time of the travel event, during the travel event, or after the arrival time of the travel event;
computing an adjusted duration for each calendar item that is scheduled to take place during the travel event, wherein each adjusted duration that is time-adjusted based on the time zones where that calendar item is scheduled to take place during the travel event; and
scheduling each calendar item, that is scheduled to take place during the travel event, according to the adjusted duration of that calendar item that is time-adjusted based on the time zones where that calendar item is scheduled to take place during the travel event; and
wherein displaying the single schedule in the main user interface of the calendar application, further comprises:
displaying the calendar items that are scheduled to take place during the travel event such that each calendar item is time-adjusted based on one or more time zones where that calendar item is scheduled to take place, and wherein any calendar items that take place over two or more time zones are displayed within the single schedule using the adjusted duration for that calendar item.

7. The method according to claim 1, further comprising:
determining, based on travel information, whether each calendar item is scheduled to take place before the departure time of the travel event, during the travel event, or after the arrival time of the travel event;
scheduling each calendar item, that is scheduled to take place before the departure time of the travel event, according to a scheduled time in the first time zone where that calendar item is scheduled to take place; and
wherein displaying the single schedule in the main user interface of the calendar application, further comprises:
displaying each calendar item that is scheduled to take place before the departure time of the travel event according to a scheduled time in the first time zone where that calendar item is scheduled to take place.

8. The method according to claim 1, wherein computing an adjusted duration for the travel event that is time-adjusted based on time zones that the travel event takes place over, comprises:
determining a relative time zone differential between the first time zone of the starting location and the second time zone of the ending location;
determining whether the second time zone of the ending location lags or leads the first time zone of the starting location; and
when the second time zone of the ending location lags the first time zone of the starting location: computing the adjusted duration of the travel event based on the difference between an actual total travel time between the ending location and the starting location, and the relative time zone differential.

9. The method according to claim 8, wherein computing an adjusted duration for the travel event that is time-adjusted based on time zones that the travel event takes place over, further comprises:
determining a relative time zone differential between the first time zone of the starting location and the second time zone of the ending location;
determining, whether the second time zone of the ending location lags or leads the first time zone of the starting location; and
when the second time zone of the ending location leads the second time zone of the starting location: computing the adjusted duration for the travel event based on the sum of an actual total travel time between the ending location and the starting location, and the relative time zone differential.

10. The method according to claim 9, wherein the actual total travel time between the ending location and the starting location is:
an actual total travel time between an anticipated arrival of the user at the ending location and an anticipated departure of the user from the starting location.

11. A calendar system comprising:
a processor configured to execute a calendar application to generate a calendar, wherein the calendar application is configured to:
create a travel event on the calendar based on travel information, wherein the travel event takes place over a first time zone of a starting location that a user departs from at a departure time, and a second time zone of an ending location that the user arrives at an arrival time;
compute an adjusted duration for the travel event that is time-adjusted, based on time zones that the travel event takes place over, to account for any transitions between the time zones that occur during the travel event;
schedule the travel event according to the adjusted duration;
detect other calendar items that are to be displayed within the calendar; and
a display configured to display a main user interface generated by the calendar application, wherein the main user interface presents an adjusted view comprising a single schedule that includes the travel event and each of the other calendar items, wherein the travel event is displayed within the single schedule such that the travel event is rendered to have the adjusted duration that is time-adjusted to account for any transitions between the time zones that occur during the travel event.

12. The calendar system according to claim 11, wherein the calendar application is further configured to:
determine, based on travel information, whether each calendar item is scheduled to take place: before the departure time of the travel event, during the travel event, or after the arrival time of the travel event;
compute an adjusted duration for each of the other calendar items that is scheduled to take place during the travel event, wherein each adjusted duration that is time-adjusted based on the time zones where that calendar item is scheduled to take place during the travel event; and
schedule each of the other calendar items, wherein each calendar item that is scheduled to take place before the departure time of the travel event is scheduled according to a scheduled time in the first time zone where that calendar item is scheduled to take place, wherein each calendar item that is scheduled to take place after the arrival time of the travel event is scheduled so that it is time-adjusted to an equivalent scheduled time in the second time zone, and wherein each calendar item that is scheduled to take place during the travel event is scheduled according to have the adjusted duration of that calendar item that is time-adjusted based on the time zones where that calendar item is scheduled to take place during the travel event.

13. The calendar system according to claim 12, wherein:
each calendar item that is scheduled to take place after the arrival time of the travel event is displayed so that it is time-adjusted according to the equivalent schedule time in the second time zone where that calendar item is scheduled to take place;
each calendar item that is scheduled to take place during the travel event is displayed such that each calendar item is time-adjusted based on one or more time zones where that calendar item is scheduled to take place, and wherein any calendar items that take place over two or more time zones during the travel event are displayed within the single schedule using the adjusted duration for that calendar item; and
wherein each calendar item that is scheduled to take place before the departure time of the travel event is displayed according to a scheduled time in the first time zone where that calendar item is scheduled to take place.

14. The calendar system according to claim 11, wherein the calendar application is configured to:
determine a relative time zone differential between the first time zone of the starting location and the second time zone of the ending location;
determine whether the second time zone of the ending location lags or leads the first time zone of the starting location; and
compute the adjusted duration for the travel event based on either: the difference between an actual total travel time between the ending location and the starting location, and the relative time zone differential when the second time zone lags the first time zone; or the sum of an actual total travel time between the ending location and the starting location, and the relative time zone differential when the second time zone leads the second time zone.

15. The calendar system according to claim 11, wherein the adjusted duration for the travel event is time-adjusted to start at the departure time in the first time zone and end at the arrival time in the second time zone such that the travel event is scheduled over a time range that reflects the departure time in the first time zone and the arrival time in the second time zone to provide an adjusted view of the calendar that takes into account travel between time zones during travel event including either time lost when the time zone of the ending location lags the time zone of the starting location, or time gained when the time zone of the ending location leads the time zone of the starting location.

16. A computing system, comprising:
a display;
a processor; and
a memory, wherein the memory comprises computer-executable instructions that are capable of causing the computing system to:
create a travel event on a calendar based on travel information, wherein the travel event takes place over a first time zone of a starting location that a user departs from at a departure time, and a second time zone of an ending location that the user arrives at an arrival time;
compute an adjusted duration for the travel event that is time-adjusted, based on time zones that the travel event takes place over, to account for any transitions between the time zones that occur during the travel event;
schedule the travel event according to the adjusted duration;
detect other calendar items that are to be displayed in a main user interface of a calendar application; and
render, at the display, a single schedule in the main user interface of the calendar application that includes the travel event and each of the other calendar items, wherein the travel event is displayed within the single schedule such that the travel event is rendered to have the adjusted duration that is time-adjusted to account for any transitions between the time zones that occur during the travel event.

17. The computing system of claim 16, wherein the computer-executable instructions are further capable of causing the computing system to:
determine, based on travel information, whether each calendar item is scheduled to take place: before the departure time of the travel event, during the travel event, or after the arrival time of the travel event;
compute an adjusted duration for each calendar item that is scheduled to take place during the travel event, wherein each adjusted duration that is time-adjusted based on the time zones where that calendar item is scheduled to take place during the travel event; and
schedule each calendar item, wherein each calendar item that is scheduled to take place before the departure time of the travel event is scheduled according to a scheduled time in the first time zone where that calendar item is scheduled to take place, wherein each calendar item that is scheduled to take place after the arrival time of the travel event is scheduled so that it is time-adjusted to an equivalent scheduled time in the second time zone, and wherein each calendar item that is scheduled to take place during the travel event is scheduled according to have the adjusted duration of that calendar item that is time-adjusted based on the time zones where that calendar item is scheduled to take place during the travel event;
render, at the display, the single schedule in the main user interface of the calendar application that includes each of the other calendar items by causing the computing system to:
render each calendar item, that is scheduled to take place after the arrival time of the travel event, so that it is time-adjusted according to the equivalent schedule time in the second time zone where that calendar item is scheduled to take place;
render each calendar item, that is scheduled to take place during the travel event, such that each calendar item is time-adjusted based on one or more time zones where that calendar item is scheduled to take place, and wherein any calendar items that take place over two or more time zones are displayed within the single schedule using the adjusted duration for that calendar item; and
render each calendar item, that is scheduled to take place before the departure time of the travel event, according to a scheduled time in the first time zone where that calendar item is scheduled to take place.

18. The computing system of claim 17, wherein the computer-executable instructions are further capable of causing the computing system to:
determine a relative time zone differential between the first time zone of the starting location and the second time zone of the ending location;
determine whether the second time zone of the ending location lags or leads the first time zone of the starting location;
compute the adjusted duration of the travel event based on either: the difference between an actual total travel time between the ending location and the starting location, and the relative time zone differential when the second time zone lags the first time zone; or the sum of an actual total travel time between the ending location and the starting location, and the relative time zone differential when the second time zone leads the second time zone.

19. The computing system of claim 16, wherein the adjusted duration for the travel event is time-adjusted to:
start at the departure time in the first time zone, and end at the arrival time in the second time zone such that the travel event is scheduled over a time range that reflects the departure time in the first time zone and the arrival time in the second time zone.

20. The computing system of claim 19, wherein the adjusted duration for the travel event is time-adjusted to provide an adjusted view of the calendar that takes into account travel between time zones during travel event including either time lost when the time zone of the ending location lags the time zone of the starting location, or time gained when the time zone of the ending location leads the time zone of the starting location.
